(19) United States
(12) Patent Application Publication
(10) Pub. No.: US 2006/0103644 A1
(43) Pub. Date: May 18, 2006

(54) Display apparatus and method for eliminating incidental image thereof

(75) Inventor: Chang-ik Choi, Suwon-si (KR)

Correspondence Address: STANZIONE & KIM, LLP, Suite 440, 919 18th Street, N.W., Washington, DC, 20006, US

(73) Assignee: Samsung Electronics Co., Ltd.

(21) Appl. No.: 11/245,011

(22) Filed: Oct. 7, 2005

(30) Foreign Application Priority Data
Nov. 6, 2004 (KR) 10-2004-0090169

(51) Int. Cl. G09G 3/30

(52) U.S. Cl. 345/214; 345/77

(57) ABSTRACT

A display apparatus having a display panel on which an image is displayed, including: an image sensing unit sensing whether the displayed image is still; a video processing unit capable of changing a video gain of a video signal applied to the display panel; and a controller controlling the video processing unit to change the video gain of the video signal, when it is determined that the displayed image has been still for more or than a predetermined period of time, based on the sensed result from the image sensing unit.

### CROSS-REFERENCE TO RELATED APPLICATION

This application claims the benefit of Korean Patent Application No. 2004-90169, filed on Nov. 6, 2004, in the Korean Intellectual Property Office, which is hereby incorporated by reference for all purposes as if fully set forth herein.

### BACKGROUND OF INVENTION

1. Field of Invention

The present invention relates to a display apparatus and a method for eliminating an incidental image thereof, and more particularly, to a display apparatus and a method for eliminating an incidental image thereof that is generated in the display panel.

2. Description of the Related Art

Conventionally, a display apparatus includes a cathode ray tube (CRT), which is heavy, large, and energy inefficient. The CRT has been replaced with a flat panel display apparatus having an active matrix driving mechanism that displays images by controlling a light transmission rate of liquid crystal with a switching device, such as a thin film transistor (TFT).

The flat panel display is known as a liquid crystal display (LCD). LCDs are used in a wide range of display devices, such as computer monitors, television monitors, etc. For example, when the LCD apparatus is used as a computer monitor or a television monitor, a same video signal is frequently input into the monitor for a long period of time to display a same image or still image, such as a display for picture control.

When the still image is displayed for a long period of time, the LCD display apparatus described above generates an incidental image between a bright portion and a dark portion of the image due to fluorescent abrasion of a partition wall of a cell. In addition, since the LCD display apparatus cannot promptly respond to a video signal, when the still image is converted into a different image after being displayed for a long period of time, picture quality is adversely affected because an incidental image of the previous still image remains on the LCD display. The incidental image is an impression of the image that remains on the LCD display or screen after the image signal has been removed

### SUMMARY OF THE INVENTION

The present invention provides a display apparatus that is capable of preventing an incidental image from being generated on a display panel of the display apparatus, and a method for eliminating an incidental image displayed on the display panel.

According to an embodiment of the invention, there is provided a method for controlling a display apparatus having a display panel on which an image is displayed, including determining whether the displayed image is still, and changing a video gain of a video signal applied to the display panel when the displayed image is still for at least a predetermined period of time, based on the determined result. Video gain is a range of light-to-dark values of image that is proportional to the voltage difference between the black and white voltage levels of the video signal. Video gain is expressed by a voltage level of the whitest whites in an active picture signal and is related to the contrast of the video image.

It is to be understood that both the foregoing general description and the following detailed description are exemplary and explanatory and are intended to provide further explanation of the invention as claimed.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is a block diagram illustrating control by a display apparatus according to an embodiment of the invention.

FIG. 2 is a flow chart illustrating a method of controlling a display apparatus according to an embodiment of the invention.

FIG. 3 is a diagram illustrating a change in video gain in a display apparatus according to an embodiment of the invention.

### DESCRIPTION OF THE ILLUSTRATED EMBODIMENTS

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

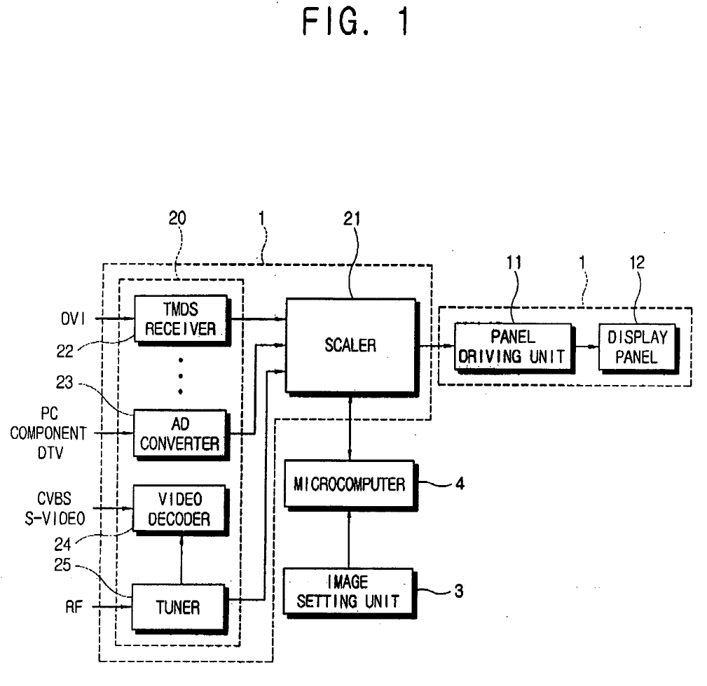

According to an embodiment of the invention shown in FIG. 1, a display apparatus includes a display unit 1, a video processing unit 2, an image sensing unit 3, and a microcomputer 4.

Referring to FIG. 1, the display unit 1 receives a video signal from the video processing unit 2 to display an image. The display unit 1 includes a display panel 12 displaying the image, and a panel driving unit 11 processing the video signal to allow the processed video signal to be displayed on the display panel 12. According to the invention, the display panel 12 refers to a LCD panel using a thin film transistor (TFT) as a switching device, a plasma display panel (PDP), or to any other display panel in which incidental images can be generated when a still image is continuously displayed for a predetermined period of time.

The video processing unit 2 includes a scaler 21 scaling the video signal, and a signal converting unit 20 converting the received video signal into a video signal that can be processed by the scaler 21. In a non-limiting example, and as shown in FIG. 1, the signal converting unit 20 may include a transition minimized differential signaling (TMDS) receiver 22, an analog to digital signal (A/D) converter 23, a video decoder 24, and a tuner 25.

The TMDS receiver 22 divides a digital video signal, such as a DVI (digital video interface) signal, etc., into an RGB digital signal and an H/V synchronous signal and outputs the divided signals to the scaler 21.

The A/D converter 23 converts analog video signals, such as component signal and PC signal, etc., into digital video signals and outputs the digital signals to the scaler 21.

The video decoder 24 decodes analog video signals input from an analog connection terminal, e.g., a composite video broadcast signal (CVBS) or S-video signal, etc., and outputs the decoded analog signal video signals to the scaler 21.

The tuner 25 receives a broadcast signal, such as an RF signal input from an antenna (not shown) and the like, and outputs the broadcast signal to the video decoder 24.

The scaler 21 scales, e.g., formats, the video signal received from the signal converting unit 20 so that the video signal can be displayed on the display panel 12 and outputs the scaled video signal to the panel driving unit 11. In a non-limiting example, the scaler 21 scales and converts the video signal into a video signal of a reference video gain. Thus, for example, the scaler 21 is capable of changing and then displaying the video gain of the video signal that is output to the panel driving unit 11 according to a control signal from the microcomputer 4.

The image sensing unit 3 determines whether an image displayed on the display panel is still or static, e.g., the same image is displayed on the display panel for at least a predetermined period of time, and communicates such determination with the microcomputer 4. The image sensing unit 3 is supplied with a video signal from the video processing unit 2 and compares the current video data with the immediately previous video data on a frame-by-frame basis to determine whether the current video data and the immediately previous image data are the same, and outputs a sensed signal to the microcomputer 4. Alternatively, the image sensing unit 3 may receive video data output to the display panel 12 from the panel driving unit 11 or video data output to the driving panel unit from the scaler 21 and then compare the current video data with the immediately previous video data. It is understood that the video signal may be input into the video processing unit 2 from an external input source (not shown).

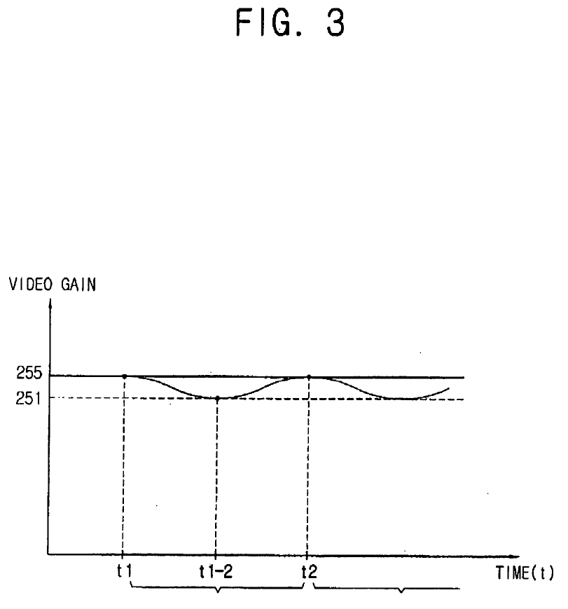

When it is determined that the same video signal is input and an image displayed on the display panel 12 is still for at least a predetermined period of time based on the sensed result from the image sensing unit 3, the microcomputer 4 controls or instructs the scaler 21 to change and then output a video gain of the video signal to the panel driving unit 11. The video gain of the video signal is changed as much as a predetermined width corresponding to a predetermined period of time (T) (shown in FIG. 3). The predetermined width of the video gain for the video signal to be changed is sufficiently minimal or slight so that a user cannot visually recognize a change in brightness and/or contrast of an image displayed on the display panel 12 when the video gain is changed.

The microcomputer 4 receives a signal from the image sensing unit 3 and determines that the current image is a still image when a ratio of a size of the still region of the current image to a size of the whole region of the immediately previous image is equal to or greater than a predetermined amount. For example, when the current image is the same as the previous image or the ratio of the size of the still region of the current image to the size of the whole region of the immediately previous region is equal to or greater than a predetermined ratio, for example, 90%, the microcomputer 4 determines that the current image is a still image and controls the scaler 21 to change the video gain.

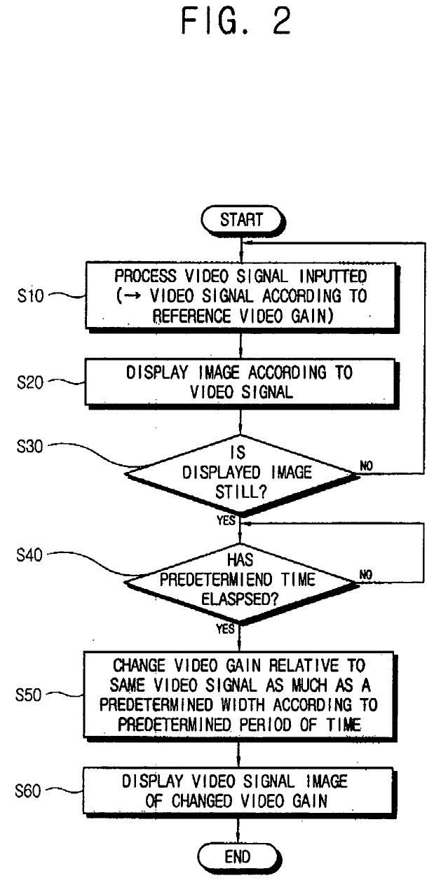

A method for eliminating an incidental image in a display apparatus according to an embodiment of the invention is described hereinbelow with reference to FIGS. 2 and 3.

Referring to FIG. 2, in operation 10, the signal converting unit 20 converts a video signal into a video signal capable of being processed by the scaler 21 and outputs the converted video signal to the scaler 21. The scaler 21 then scales the video signal to be in a format capable of being displayed on a particular display panel 12 and outputs the scaled video signal to a panel driving unit 11. The scaler 21 converts the scaled video signal into the video signal of a reference video gain.

In operation 20, the panel driving unit 11 processes the video signal received from the video processing unit 2 and displays an image on the display panel 11. While the panel driving unit 11 is processing the video signal, the image sensing unit 3 continuously outputs a signal to the microcomputer 4 determining or sensing whether the image displayed is a still image. In operation 30, the microcomputer 4 determines whether the image being currently displayed is a still image according to the signal received from the image sensing unit 3. Upon determining that the current image is a still image, in operation 40, the microcomputer 4 determines whether the displayed image has been in a still or static state for at least a predetermined period of time. Upon determining that the image has been in the still state for at least the predetermined period of time, in operation 50, the microcomputer 4 controls the scaler 21 to output the video gain of the video signal to the panel driving unit 11. As discussed above, the video gain of the video signal is changed as much as a predetermined width of the signal corresponding to a predetermined period of time (T).

FIG. 3 illustrates a non-limiting example of changing the video gain of a predetermined image signal. In FIG. 3, a same video signal of a display, e.g., white display, having a reference video gain of 255 db is input for a predetermined period of time, t1, and displayed for t1 on the display panel 12. At this time, the microcomputer 4 determines whether more than a predetermined amount, e.g., 90%, of the entire display is a still image for t1, and controls the scaler 21 to change the video gain of the video signal on the white display to a sine-like waveform having a range between 255 db and 251 db.

In operation 60, the panel driving unit 11 receives and processes the video signal having the changed video gain and displays a corresponding video image on the display panel 12. As such, the image (white display) displayed on the display panel 12 is slightly or minimally changed, e.g., brightness, contrast, etc., according to the predetermined period of timeT such that the user is unable to visually perceive any change in the displayed image (white image).

Thus, according to the invention, a display apparatus slightly or minimally changes a video gain of the video signal periodically in a range that prevents a user from visually perceiving the change when the same video signal has been inputted for a long time, e.g., t1. As a result, an incidental image of the previous still image can be blocked or eliminated when the still image of the same video signal is switched to another image after a predetermined period of time elapses.

According to an embodiment of the invention, a microcomputer 4 of at least any of the display apparatus discussed above is able to suspend an operation for eliminating an incidental image, described above, at any time while performing the incidental image eliminating operation (change of video gain) when a video signal is input that is different from the immediately previous image, e.g., when a moving image is displayed. Further, a scaler 21 for at least any of the display apparatus discussed is able to process the video signal according to a general reference video gain.

As described in the embodiments of the invention discussed above, when the ratio of the still region of the current image to the whole region of the immediately previous region is equal to or greater than a predetermined ration, for example, 90%, for a predetermined period of time, t1, the image actually displayed on the display panel 12 is slightly or minimally changed by changing the video gain of the inputted video signal as much as a predetermined width corresponding to a predetermined period of time, T.

Accordingly, an incidental image of the previous still image may be eliminated when a still image of a same video signal is switched to another image after the still image is displayed for a at least a predetermined period of time, by periodically changing the image displayed on the display panel 11 in a range that prevents a user from visually perceiving the change.

According to embodiments of the invention discussed above, a display apparatus can eliminate an incidental image generated in a display panel.

What is claimed is:

1. A display apparatus having a display panel on which an image is displayed, comprising:
an image sensing unit sensing whether the displayed image is a still image;
a video processing unit changing a video gain of a video signal applied to the display panel; and
a controller controlling the video processing unit to change the video gain when it is determined that the displayed image is still for at least a predetermined period of time.

2. The display apparatus of claim 2, wherein the controller controls the video processing unit to change the video gain of the video signal which fluctuates within a predetermined width at intervals for a predetermined time when the displayed image is still for at least the predetermined period of time.

3. The display apparatus of claim 1, wherein the controller determines that the displayed image is still when a ratio of a size of a still region of the displayed image to a size of a whole region of an immediately previous image is at least a predetermined value.

4. The display apparatus of claim 3, wherein the video processing unit comprises a scaler converting an externally input video signal into a video signal of a reference video gain capable of being displayed on the display panel and changing and outputting the video gain of the signal applied to the display panel according to a control signal from the controller.

5. The display apparatus of claim 2, wherein the controller determines that the displayed image is a still image when a ratio of a size of a still region of the displayed image to a size of a whole region of an immediately previous image is at least a predetermined value.

6. The display apparatus of claim 5, wherein the video processing unit comprises a scaler converting an externally input video signal into a video signal of a reference video gain capable of being displayed on the display panel and changing and outputting the video gain of the signal applied to the display panel according to a control signal from the controller.

7. The display apparatus of claim 5, wherein the display panel is a liquid crystal display panel or a plasma display panel.

8. A method of controlling a display apparatus having a display panel on which an image is displayed, comprising:
determining whether the displayed image is still; and
changing a video gain of a video signal applied to the display panel when the displayed image is still for at least a predetermined period of time, based on the determined result.

9. An apparatus having a flat panel display on which an image is displayed, comprising:
an image sensor sensing whether the displayed image is still;
a video processor changing a video gain of a video signal applied to the flat panel display; and
a controller controlling the video processing unit to change the video gain when determining that the displayed image is a still image,
wherein the video processor comprises:
a signal converter receiving and converting an externally input video signal into a video signal of a reference video gain, and
a scaler scaling the video signal of the reference video gain and outputting the scaled video signal of the reference video gain to the flat panel display, and
wherein the controller determines that the displayed image is the still image when a ratio of a size of a still region of the displayed image to a size of a whole region of an immediately previous image is at least a predetermined value and the image is still for at least a predetermined period of time.
